(19) United States
(12) Patent Application Publication
(10) Pub. No.: US 2009/0006560 A1
(43) Pub. Date: Jan. 1, 2009

(54) Terminating An Application Message Subscription

(76) Inventors: Kulvir S. Bhogal, Forth Worth, TX (US); John J. Duigenan, Long Island City, NY (US); Kwang S. Kang, Astoria, NY (US); Paul D. Lewis, Round Rock, TX (US); Ravi Ravisankar, Austin, TX (US); John J. Wang, Gaithersburg, MD (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/769,243

(22) Filed: Jun. 27, 2007

(51) Int. Cl. G06F 15/16

(52) U.S. Cl. 709/206

(57) ABSTRACT

Methods, systems, and products are disclosed for terminating an application message subscription that include: receiving, by messaging middleware of a subscribing client device, application messages having one or more message topics on one or more message streams from one or more message transmitting devices; receiving, by the messaging middleware from a stream administration server, a subscription termination message specifying a particular message topic for application messages that the subscription client device is no longer authorized to receive; and ceasing, by the messaging middleware, to provide the received application messages having the particular message topic to an application on the subscribing client device, including providing the received application messages having other message topics to the application.

### BACKGROUND OF THE INVENTION

1. Field of the Invention

The field of the invention is data processing, or, more specifically, methods, systems, and products for terminating an application message subscription.

2. Description Of Related Art

Messaging environments are generally available to provide data communication between message transmitting devices and message receiving devices using messages. A message is a quantity of data that includes one or more data fields and is passed from a message producer installed on a message transmitting device to a message consumer installed on a message receiving device. A message may represent, for example, numeric or textual information, images, encrypted information, and computer program instructions. A messaging environment may support point-to-point messaging, publish and subscribe messaging, or both. In a point-to-point messaging environment, a message producer may address a message to a single message consumer. In a publish and subscribe messaging environment, a message producer may publish a message to a particular channel or topic and any message consumer that subscribes to that channel or topic receives the message. Because message producers and message consumers communicate indirectly with each other via a channel or topic in a publish and subscribe environment, message transmission is decoupled from message reception. As a consequence, neither producers nor consumers need to maintain state about each other, and dependencies between the interacting participants are reduced or eliminated. A publish and subscribe environment may, therefore, allow message publishers and message subscribers to operate asynchronously.

For further explanation of a messaging environment, FIG. 1 sets forth a block diagram illustrating a typical messaging environment for data communications that includes a message transmitting device (100), a message receiving device (104), and a message administration server (102). The message transmitting device (100) is a computer device having installed upon it a message producer (110), a set of computer program instructions configured for transmitting messages to the message administration server (102) for delivery to a message receiving device. In the example of FIG. 1, the message producer (110) transmits messages to the message administration server (102) on a message stream (106). The message transmitting device (100) may produce the transmitted messages by generating the messages from data of the message transmitting device itself or data received from some other source. The message receiving device (104) is a computer device having installed upon it a message consumer (112), a set of computer program instructions configured for receiving messages from the message administration server (102). In the example of FIG. 1, the message consumer (112) receives the messages from the message administration server (102) on a message stream (108). In the example of FIG. 1, the message stream (106) and the message stream (108) are data communication channels implemented using, for example, the User Datagram Protocol (‘UDP’) and the Internet Protocol (‘IP’).

In either a point-to-point messaging environment or a publish and subscribe messaging environment, the messages transmitted from message transmitting devices to message receiving devices typically pass through the message administration server (102). The message administration server (102) is computer device having installed upon it a message administration module (114), computer program instructions configured for administering the messages transmitted from the message producer (110) to the message consumer (112). Examples of message administration modules may include the IBM WebSphere® MQ, the Open Message Queue from Sun Microsystems, and the OpenJMS from The OpenJMS Group. In a point-to-point messaging environment, the message administration module (114) provides message queuing for the message consumer (112) as the message administration module (114) receives messages addressed to the consumer (112) from various message providers. In a publish and subscribe messaging environment, the message administration module (114) administers the various channels or topics to which message producers publish and message consumers subscribe. In either message environment, the message administration module (114) may also provide security services to ensure that the only messages arriving at the messaging consumer (112) from the message producer (110) are those messages that the message consumer (112) is authorized to receive and that the message producer (110) is authorized to send. Current messaging environments such as, for example, the one described above with reference to FIG. 1, have certain drawbacks. Messages transmitted to a message administration server from a message transmitting device for delivery to a message receiving device are delayed in the message administration server until the message administration server can process the messages. The message processing that occurs in the message administration server typically increases the overall messaging latency of the messaging environment and decreases the overall speed for transmitting data in the data communications environment. Messaging latency is the time period beginning when the message producer transmits a message and ending when the message consumer receives the message.

In many data communication environments, even slight increases in messaging latency are costly. Consider, for example, a financial market data environment. A financial market data environment is a data processing environment used to communicate information about financial markets and participants in financial markets. In a financial market data environment, a message is commonly referred to as a ‘tick’ and represents financial market data such as, for example, financial quotes or financial news. Financial quotes include bid and ask prices for any given financial security. A ‘bid’ refers to the highest price a buyer is willing to pay for a security. An ‘ask’ refers to the lowest price a seller is willing to accept for a security. In a financial market data environment, a message producer may provide quotes for the purchase or sale of financial securities based on real-time financial market conditions, and a message consumer may buy and sell financial securities based on financial quotes. When a message consumer buys or sells a financial security based on the quoted price provided by the message producer, the ability of a message consumer to obtain the bid or ask in the quote for the financial security is largely influenced by messaging latency in the financial market data environment. The higher the messaging latency, the less likely a buy or sell order generated by the message consumer will execute at or near the price stated in the financial quote. In fact, a highly volatile security may fluctuate in price dramatically over a time period of a few seconds.

Current solutions to reduce messaging latency are to remove the message administration server from the messaging environment. In such current solutions, the message transmitting devices send messages directly to message receiving devices. The drawback to such current solutions is that removing the message administration server reduces the ability to effectively provide centralized administration functionality typically afforded by the message administration server for the messaging environment. In particular, removing the message administration server reduces the ability to effectively administer application message subscriptions using a single device in the messaging environment such as, for example, administering message subscription initiation and administering message subscription termination. As such, readers will appreciate that room for improvement exists in application message subscription administration, and in particular application message subscription termination.

### SUMMARY OF THE INVENTION

Methods, systems, and products are disclosed for terminating an application message subscription that include: receiving, by messaging middleware of a subscribing client device, application messages having one or more message topics on one or more message streams from one or more message transmitting devices; receiving, by the messaging middleware from a stream administration server, a subscription termination message specifying a particular message topic for application messages that the subscription client device is no longer authorized to receive; and ceasing, by the messaging middleware, to provide the received application messages having the particular message topic to an application on the subscribing client device, including providing the received application messages having other message topics to the application.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram illustrating a typical messaging environment for data communications.

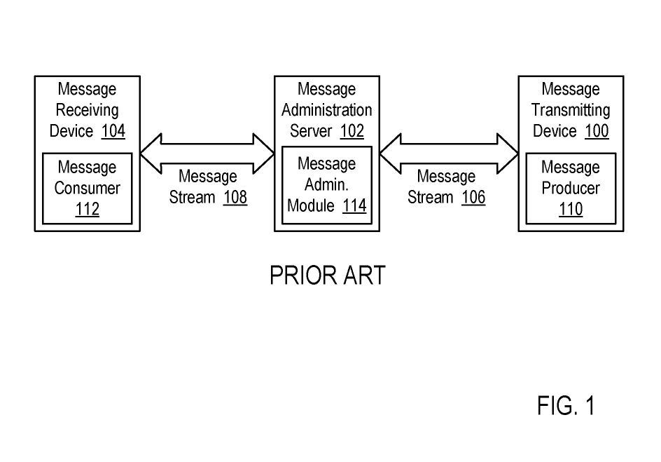

FIG. 2 sets forth a network and block diagram illustrating an exemplary computer data processing system for terminating an application message subscription according to exemplary embodiments of the present invention.

FIG. 3 sets forth a block diagram of automated computing machinery comprising an exemplary subscribing client device useful in terminating an application message subscription according to exemplary embodiments of the present invention.

FIG. 4 sets forth a flowchart illustrating an exemplary method of terminating an application message subscription according to exemplary embodiments of the present invention.

FIG. 5 sets forth a flowchart illustrating a further exemplary method of terminating an application message subscription according to exemplary embodiments of the present invention.

FIG. 6 sets forth a flowchart illustrating a further exemplary method of terminating an application message subscription according to exemplary embodiments of the present invention.

### DETAILED DESCRIPTION OF EXEMPLARY EMBODIMENTS

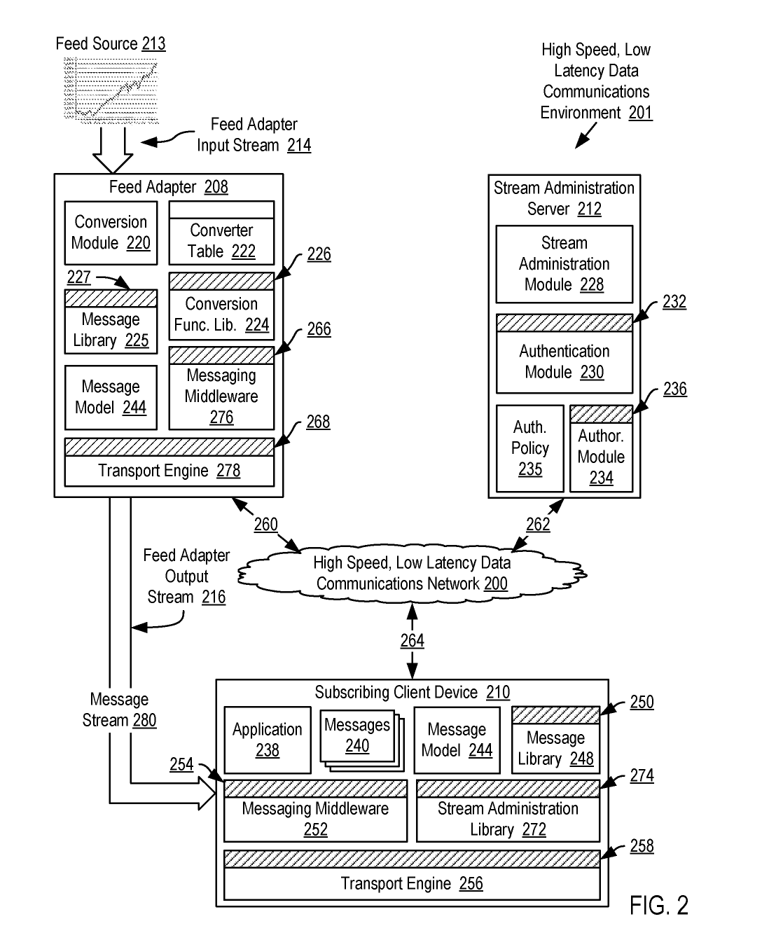

Exemplary methods, systems, and products for terminating an application message subscription according to embodiments of the present invention are described with reference to the accompanying drawings, beginning with FIG. 2. FIG. 2 sets forth a network and block diagram illustrating an exemplary computer data processing system for terminating an application message subscription according to embodiments of the present invention. The system of FIG. 2 operates generally for terminating an application message subscription according to embodiments of the present invention as follows: Messaging middleware (252) of a subscribing client device (210) receives application messages (240) having one or more message topics on one or more message streams (280) from one or more message transmitting devices (208). In the example of FIG. 2, a message transmitting device is implemented as a feed adapter (208). The messaging middleware (252) of the subscribing client device (210) receives a subscription termination message from a stream administration server (212). The subscription termination message specifies a particular message topic for application messages that the subscription client device (210) is no longer authorized to receive. The messaging middleware (252) of the subscribing client device (210) ceases to provide the received application messages (240) having the particular message topic to an application (238) on the subscribing client device (210), and provides the received application messages (240) having other message topics to the application (238).

In the example of FIG. 2, terminating an application message subscription according to embodiments of the present invention occurs in a high speed, low latency data communications environment (201). The high speed, low latency data communications environment (201) illustrated in FIG. 2 includes a high speed, low latency data communications network (200). The high speed, low latency data communications network (200) connects the stream administration server (212), the subscribing client device (210), and the message transmitting device (208) together for data communications by providing the infrastructure for connecting such devices (208, 212, 210). The network (200) of FIG. 2 is termed ‘high speed, low latency’ because the application messages sent between devices connected to the network (200) on message streams administered by the stream administration server (212) bypass the stream administration server (212). For example, the application messages on the message stream (280) from the feed adapter (208) to the subscribing client device (210) bypass the stream administration server (212). Although such messages are not delayed for processing in the stream administration server (212), the stream administration server (212) retains administration of the stream (280) between devices connected to the high speed, low latency data communications network (200).

Further contributing to the ‘high speed, low latency’ nature of network (200), readers will note that the network (200) does not include a router, that is a computer networking device whose primary function is to forward data packets across a network toward their destinations. Rather, each device (208, 212, 210) provides its own routing functionality for data communication through a direct connection with the other devices connected to the network (200). Because the network (200) does not include a computer networking device dedicated to routing data packets, the network (200) of FIG. 2 may be referred to as a ‘minimally routed network.’ Although the exemplary network (200) illustrated in FIG. 2 does not include a router, such a minimally routed network is for explanation only. In fact, some high speed, low latency networks useful in terminating an application message subscription according to embodiments of the present invention may include a router.

The high speed, low latency data communications environment (201) depicted in FIG. 2 includes a message stream (280). A message stream is a data communication channel between a communications endpoint of a sending device and a communications endpoint of at least one receiving device. A communications endpoint is typically composed of a network address and a port for a sending device or a receiving device. A message stream may be implemented as a multicast data communication channel. In a multicast data communication channel, a one-to-many relationship exists between a destination address for a message and the communication endpoints of receiving devices. That is, each destination address identifies a set of communication endpoints for receiving devices to which each message of the stream is replicated. A multicast data communication channel may be implemented using, for example, the User Datagram Protocol (‘UDP’) and the Internet Protocol (‘IP’). In addition to a multicast data communication channel, the message stream may be implemented as a unicast data communication channel. In a unicast data communication channel, a one-to-one relationship exists between a destination address for a message and a communication endpoint of a receiving device. That is, each destination address uniquely identifies a single communication endpoint of a single receiving device. A unicast data communication channel may be implemented using, for example, the Transmission Control Protocol (‘TCP’) and IP.

The exemplary system of FIG. 2 includes a stream administration server (212) connected to the high speed, low latency data communications network (200) through a wireline connection (262). The stream administration server (212) of FIG. 2 is a computer device having installed upon it a stream administration module (228), an authentication module (230), an authorization module (234), and an authorization policy (235). A stream administration module (228) is a software component that includes a set of computer program instructions configured for terminating an application message subscription according to embodiments of the present invention. The stream administration module (228) operates generally for terminating an application message subscription according to embodiments of the present invention by: receiving, from the subscribing client device (210), one or more subscription initialization requests specifying application messages for transmission to the subscribing client device (210) from the message transmitting devices (208) using the message topics; and brokering, on behalf of the subscribing client device (210), establishment of the message streams that provide the application messages having the message topics from the message transmitting devices (208) to the subscribing client device (210). The stream administration module (228) of FIG. 2 may broker establishment of the message streams by: authenticating the subscribing client device (210); authorizing the subscribing client device (210) to receive application messages (240) for the message topics specified in the subscription initiation requests; and providing the subscribing client device (210) with a data communications endpoint for each message stream for receiving application messages on that message stream. After the subscribing client device (210) receives application messages (240) on the message streams, the stream administration module (228) of FIG. 2 may also operate to terminating an application message subscription according to embodiments of the present invention by determining that the subscribing client device (210) is not authorized to receive the application messages having the particular message topic; and transmitting a subscription termination message to the subscribing client device (210).

The authentication module (230) of FIG. 2 is a set of computer program instructions capable of providing authentication security services to the stream administration module (228) through an exposed authentication application programming interface (‘API’) (232). Authentication is a process of verifying the identity of an entity. In the exemplary system of FIG. 2, the authentication module (230) verifies the identity of the subscribing client device (210). The authentication module (230) may provide authentication security services using a variety of security infrastructures such as, for example, shared-secret key infrastructure or a public key infrastructure.

The authorization module (234) of FIG. 2 is a set of computer program instructions capable of providing authorization security services to the stream administration module (228) through an exposed authorization API (236). Authorization is a process of only allowing resources to be used by resource consumers that have been granted authority to use the resources. In the example of FIG. 2, the authorization module (234) identifies the application messages that the subscribing client device (210) is authorized to receive on the message stream (280). The authorization module (234) of FIG. 2 provides authorization security services using an authorization policy (235). The authorization policy (235) is a set of rules governing the privileges of authenticated entities to send or receive application messages on a message stream. In a financial market data environment, for example, an authenticated entity may be authorized to receive application messages that include financial quotes for some financial securities but not other securities. The authorization policy (235) may grant privileges on the basis of an individual entity or an entity's membership in a group.

In the exemplary system of FIG. 2, feed adapter (208) is connected to the high speed, low latency data communications network (200) through a wireline connection (260). The feed adapter (208) is a computer device having the capabilities of converting application messages received on a feed adapter input stream (214) having a first format to application messages having a second format for transmission on a feed adapter output stream (216) to subscribing client devices. The feed adapter input stream (214) is a message stream from a feed source to the feed adapter (208). The feed adapter output stream (216) is a message stream administered by the stream administration server (212) from the feed adapter (208) to the subscribing client device (210).

In the example of FIG. 2, the feed adapter (208) receives application messages on the feed adapter input stream (214) from a feed source (213). The feed source (213) is a computer device capable of aggregating data into application messages and transmitting the messages to a feed adapter. In a financial market data environment, for example, a feed source (213) may be implemented as a feed source controlled by the Options Price Reporting Authority (‘OPRA’). OPRA is the securities information processor for financial market information generated by the trading of securities options in the United States. The core information that OPRA disseminates is last sale reports and quotations.

Other examples of feed sources in financial market data environment may include feed sources controlled by the Consolidated Tape Association (‘CTA’) or The Nasdaq Stock Market, Inc. The CTA oversees the dissemination of real-time trade and quote information in New York Stock Exchange and American Stock Exchange listed securities. The Nasdaq Stock Market, Inc. operates the NASDAQ Market Center_{SM} which is an electronic screen-based equity securities market in the United States. In a financial market data environment, a feed adapter input stream is referred to as a ‘financial market data feed.’

The feed adapter (208) of FIG. 2 has installed upon it a conversion module (220), a converter table (222), conversion function library (224), a message library (225), a message model (244), messaging middleware (276), and a transport engine (278). The conversion module (220) is a set of computer program instructions for converting application messages received on the feed adapter input stream (214) having a first format into application messages (240) having a second format for transmission to subscribing devices on the feed adapter output stream (216).

The conversion module (220) converts application messages from the first format to the second format according to the converter table (222). The converter table (222) of FIG. 2 is a data structure that specifies the converter functions capable of converting the application message from one format to another format. Utilizing multiple converter tables, the conversion module (220) may convert messages from a variety of input formats to a variety of output formats. In the example of FIG. 2, the converter table (222) specifies the converter functions capable of converting the application message received from the feed adapter input stream (214) having the first format to application messages (240) having the second format for transmission to subscribing client devices on the feed adapter output stream (216). The converter table (222) of FIG. 2 may be implemented using a structured document such as, for example, an eXtensible Markup Language (‘XML’) document.

The conversion function library (224) of FIG. 2 is a loadable software module that contains one or more converter functions capable of converting data fields in an application message from one format to another format or converting values of data fields from one value to another value. The converter functions contained in the conversion function library may, for example, convert a 16-bit integer to a 32-bit integer, convert a number stored in a string field to a 64-bit double floating point value, increase the value of one data field by one, or any other conversion as will occur to those of skill in the art. The conversion module (220) accesses the converter functions through a set of converter function APIs (226) exposed by the converter functions of the conversion function library (224). In the example of FIG. 2, the conversion function library (224) may be implemented as dynamically linked libraries available to the conversion module (220) at runtime, statically linked libraries linked into the conversion module (220) at compile time, dynamically loaded Java classes, or any other implementation as will occur to those of skill in the art.

In the example of FIG. 2, the application messages (240) transmitted by the feed adapter (208) have a format specified in a message model (244). The message model (244) is metadata that defines the structure and the format used to create, access, and manipulate the application messages (240) converted from the application messages (not shown) received from the feed source (213). That is, the message model (244) specifies a message format for interpreting application messages and includes one or more field specifications. Each field specification specifies a message field for storing data in an application message and includes field characteristics of the message field. In the example of FIG. 2, the message model (244) is established on both the feed adapter (208) and the subscribing client device (210) by the stream administration server (212) when the stream administration server (212) brokers a message stream to a subscribing client device. A message model may be implemented using a structured document, such as, for example, an XML document, a Java object, C++ object, or any other implementation as will occur to those of skill in the art.

In the example of FIG. 2, the conversion module (220) and the converter functions of the conversion function library (224) process the data contained in the application messages (240) using the message library (225). The message library (225) is a software module that includes a set of functions for creating, accessing, and manipulating messages (240) according to a message model (244). The message library (225) is accessible to the conversion module (220), the converter functions of the conversion function library (224), and the messaging middleware (276) through a message API (227) exposed by the message library (225).

Before the conversion module (220) of FIG. 2 performs data processing on the application messages, the conversion module (220) receives application messages (not shown) having a first format from the feed source (213). The conversion module (220) of FIG. 2 may receive the source stream messages through a receiving transport engine (not shown) of the feed adapter (208). The receiving transport engine is a software module that operates in the transport layer of the network stack and may be implemented according to the TCP/IP protocols, UDP/IP protocols, or any other data communication protocol as will occur to those of skill in the art. The receiving transport engine may provide the received application messages directly to the conversion module (220) or to the messaging middleware (276), which in turn, provides the source stream messages to the conversion module (220).

After the conversion module (220) of FIG. 2 performs data processing on the application messages received from the feed source (213), the conversion module (220) provides the application messages having the second format to the messaging middleware (276). The messaging middleware (276) of FIG. 2 is a software component that provides high availability services between the feed adapter (208), any backup feed adapter that may exist, the subscribing client device (210), and the feed source (213). In addition, the messaging middleware (276) of FIG. 2 includes a set of computer program instructions capable of receiving application messages from the conversion module (220) for transmission to the subscribing client device (210), retrieving the contents of each of the application messages, and calculating a hash value for each message in dependence upon the contents of each application message. The hash value provides the ability to rapidly filter in the application messages in the transport layer of the subscribing client device (210). The messaging middleware (276) then provides the received application messages to the transport engine (278) for transmission to a subscribing client device (210) on the feed adapter output stream (216). The conversion module (220) interacts with the messaging middleware (276) through a messaging middleware API (266) exposed by the messaging middleware (276).

The transport engine (278) of FIG. 2 is a software component operating in the transport and network layers of the OSI protocol stack promulgated by the International Organization for Standardization. The transport engine (278) provides data communications services between network-connected devices. The transport engine may be implemented according to the UDP/IP protocols, TCP/IP protocols, or any other data communications protocols as will occur to those of skill in the art. The transport engine (278) is a software module that includes a set of computer program instructions for transmitting the application messages (240) and the hash values to the subscribing client device (210). The messaging middleware (276) operates the transport engine (278) through a transport API (268) exposed by the transport engine (278). The transport engine (278) of FIG. 2 may transmit the application messages (240) and the hash values by prepending each hash value to its corresponding application message, encapsulating the application messages and the hash values provided by the messaging middleware (276) into transport packets, and transmitting the packets through the message stream (280) to the subscribing client device (210).

The subscribing client device (210) in exemplary system of FIG. 2 connects to the high speed, low latency data communications network (200) through a wireline connection (264). The subscribing client device (210) of FIG. 2 is a computer device capable of subscribing to the message streams transmitted by various feed adapters. In a financial market data environment, for example, a subscribing client device may subscribe to a tick to receive the bid and ask prices for a particular security on a message stream provided by a feed adapter controlled by a financial securities broker.

In the example of FIG. 2, the subscribing client device (210) has installed upon it an application (238), a message library (248), a message model (244), messaging middleware (252), a stream administration library (272), and a transport engine (256). The application (238) is a software component that processes data contained in the application messages (240) received from the feed adapter (208). The application (238) may process the data for utilization by the subscribing client device (210) itself, for contributing the data to another feed adapter, or for contributing the data to some other device. In a financial market data environment, the application installed on the subscribing client device may be a program trading application that buys or sells financial securities based on the quoted prices contained in ticks. The application may also be a value-adding application that contributes information to a tick such as, for example, the best bid and ask prices for a particular security, that is not typically included in the ticks provided by the feed source (213). The subscribing client device may then transmit the ticks to a feed adapter for resale to other subscribing client devices.

The application (238) processes the data contained in the application messages (240) using the message library (248). The message library (248) is software module that includes a set of functions for creating, accessing, and manipulating messages (240) according to the message model (244) that is installed on both the feed adapter (208) and the subscribing client device (210). The message library (248) is accessible to the application (238) through a message API (250) exposed by the message library (248).

The communications between the subscribing client device (210) and the stream administration server (212) may be implemented using a stream administration library (272). The stream administration library (272) is a set of functions contained in dynamically linked libraries or statically linked libraries available to the application (238) through a stream administration library API (274). Through the stream administration library (272), the subscribing client device (210) of FIG. 2 may request to initiate application message subscriptions from a feed adapter, modify an existing message subscription, or cancel a subscription. Functions of the stream administration library (272) used by the application (238) may communicate with the stream administration server (212) through network (200) by calling member methods of a CORBA object, calling member methods of remote objects using the Java Remote Method Invocation (‘RMI’) API, using web services, or any other communication implementation as will occur to those of skill in the art.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystems™. The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java™ RMI allows a Java client to access a remote Java object just like any other local Java object.

Before the application (238) processes the data contained in the application messages (240), the application (238) receives the messages (240) from the messaging middleware (252), which, in turn, receives the application messages (240) from the feed adapter (208) through the transport engine (256). The messaging middleware (252) is a software component that provides high availability services between the subscribing client device (210), the feed adapter (208), any backup feed adapters, and the stream administration module (212). In addition, the messaging middleware (252) includes a set of computer program instructions for terminating an application message subscription according to embodiments of the present invention. The messaging middleware (252) of FIG. 2 operates generally for terminating an application message subscription according to embodiments of the present invention by: receiving application messages (240) having one or more message topics on one or more message streams (280) from one or more message transmitting devices (208); receiving, from the stream administration server (212), a subscription termination message specifying a particular message topic for application messages that the subscription client device (210) is no longer authorized to receive; and ceasing to provide the received application messages (240) having the particular message topic to an application (238) on the subscribing client device (210), including providing the received application messages (240) having other message topics to the application (238).

The messaging middleware (252) of FIG. 2 may cease to provide the received application messages (240) having the particular message topic to the application (238) by determining whether a particular message stream on which the application messages (240) having the particular message topic are received provides application messages (240) having other message topics; ceasing to listen to the particular message stream on which the application messages (240) having the particular message topic are received if the particular message stream on which the application messages (240) having the particular message topic are received does not provide application messages (240) having other message topics; and filtering the application messages (240) received on the particular message stream in dependence upon the particular message topic if the particular message stream on which the application messages (240) having the particular message topic are received provides application messages (240) having other message topics. The application (238) and the stream administration library (272) interact with the messaging middleware (252) through a messaging middleware API (254).

A message topic identifies a group of application messages having some common characteristics. A message topic is typically used to classify a message based on at least some of contents of the application message. Each application message typically includes a topic data field for storing the message's message topic. Using a message topic, a subscribing client device may specify the group of messages that the subscribing client device (210) requests to receive from the feed adapter (208), or a stream administration server may specify a group of message for which a subscribing client device is no longer authorized to receive. In a financial market data environment, for example, a subscribing client device may use a topic to request to receive ticks from an OPRA feed source that contains quotes of an IBM option traded on the Chicago Board Options Exchange (‘CBOE’) that includes the best bid and best ask for the IBM option on the CBOE.

The messaging middleware (252) may filter the application messages (240) received on a particular message stream in dependence upon the particular message topic using a middleware layer constraint. A middleware layer constraint is a constraint on application messages to be provided to application software (238) installed on the subscribing client device (210). The middleware layer constraint specifies the characteristics of the application messages which application software (238) installed on the subscribing client device (210) is authorized to receive from the messaging middleware (252) of the subscribing client device (210). For example, a middleware layer constraint may specifying that the application (238) is authorized to receive all application message received on the message stream (280) except for those application messages having the particular message topic specified in a subscription termination message received from the stream administration server.

The messaging middleware (252) may also filter the application messages (240) received on a particular message stream using a transport layer constraint enforced by the transport engine (256) of the subscribing client device. The transport layer constraint may be implemented as a hash value of the particular message topic that the subscribing client device (210) is no longer authorized to receive. Using particular message topic specified in a subscription termination message received from the stream administration server (212), the messaging middleware (252) may calculate the transport layer constraint and provide the transport layer constraint to the transport engine (256) of the subscribing client device (210).

The transport engine (256) of FIG. 2 is a software component operating in the transport and network layers of the OSI protocol stack promulgated by the International Organization for Standardization. The transport engine (256) provides data communications services between network-connected devices. The transport engine may be implemented according to the UDP/IP protocols, TCP/IP protocols, or any other data communications protocols as will occur to those of skill in the art. The transport engine (256) is a software component that includes a set of computer program instructions configured for receiving, in the transport engine (256) from the feed adapter (208), application messages (240), determining whether the hash values for the application messages (240) satisfy the transport layer constraint provided by the messaging middleware (252), and administering each of the application messages (240) in dependence upon whether the hash values for the application message (240) satisfy the transport layer constraint.

As mentioned above, the transport engine (256) of FIG. 2 receives both application messages (240) and their respective hash values from the feed adapter (208). The transport engine (256) receives the application messages and the hash values by receiving transport packets through the message stream (280) from the feed adapter (208), and unencapsulating the application messages and the hash values from the received packets. The transport engine (256) of FIG. 2 then provides the application messages (240) to messaging middleware (252) of the subscribing client device (210) if the hash value appended to each application message (240) satisfies the transport layer constraint. That is, the transport engine (256) of FIG. 2 provides the application messages (240) to messaging middleware (252) if the hash value appended to each application message (240) is not a hash value specified by the transport layer constraint. In the example of FIG. 2, the messaging middleware (252) operates the transport engine (256) through a transport API (258) exposed by the transport engine (256).

The servers and other devices illustrated in the exemplary system of FIG. 2 are for explanation, not for limitation. Devices useful in terminating an application message subscription may be implemented using general-purpose computers, such as, for example, computer servers or workstations, hand-held computer devices, such as, for example, Personal Digital Assistants (‘PDAs’) or mobile phones, or any other automated computing machinery configured for data processing according to embodiments of the present invention as will occur to those of skill in the art.

The arrangement of servers and other devices making up the exemplary system illustrated in FIG. 2 are for explanation, not for limitation. Although the connections to the network (200) of FIG. 2 are depicted and described in terms of wireline connections, readers will note that wireless connections may also be useful according to various embodiments of the present invention. Furthermore, data processing systems useful according to various embodiments of the present invention may include additional servers, routers, other devices, and peer-to-peer architectures, not shown in FIG. 2, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 2.

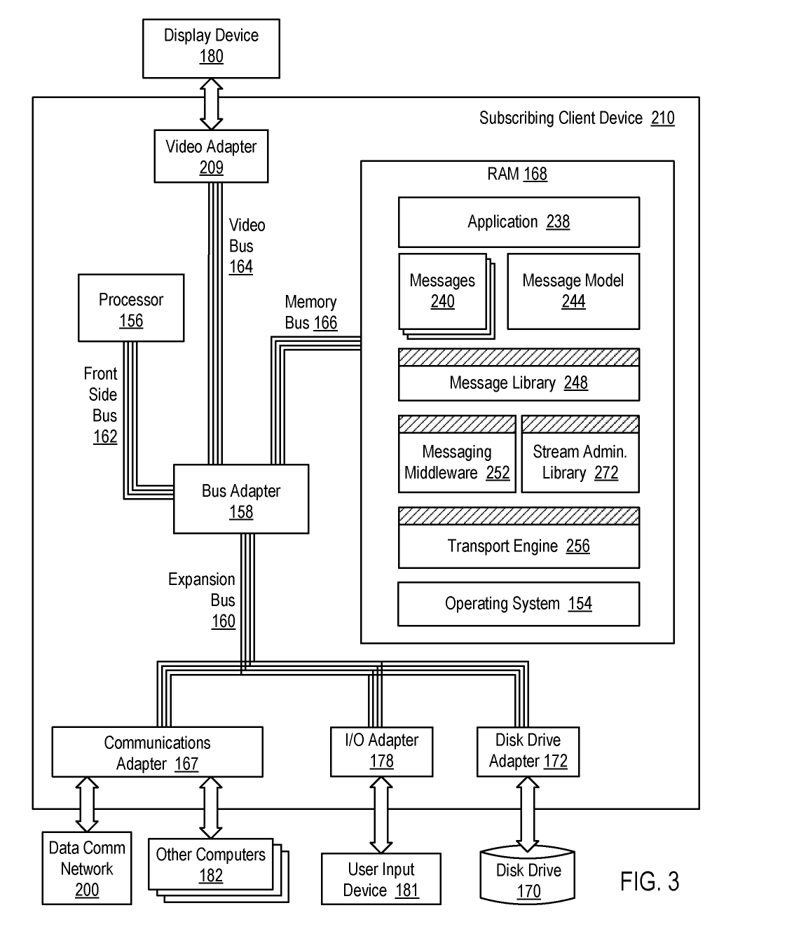

Terminating an application message subscription in accordance with the present invention in some embodiments may be implemented with one or more subscribing client devices, stream administration servers, and feed adapters. These devices and servers are, in turn, implemented to some extent at least as computers, that is, automated computing machinery. For further explanation, therefore, FIG. 3 sets forth a block diagram of automated computing machinery comprising an exemplary subscribing client device (210) useful in terminating an application message subscription according to embodiments of the present invention. The subscribing client device (210) of FIG. 3 includes at least one computer processor (156) or ‘CPU’ as well as random access memory (168) (‘RAM’) which is connected through a high speed memory bus (166) and bus adapter (158) to processor (156) and to other components of the subscribing client device.

Stored in RAM (168) is an application (238), application messages (240), message model (244), a message library (248), a messaging middleware (252) a stream administration library (272), and a transport engine (256). Each message (240) is a quantity of data that includes one or more data fields and is transmitted from one device to another on a message stream. As mentioned above, a message may represent numeric or textual information, images, encrypted information, computer program instructions, and so on. In a financial market data environment, for example, a message is commonly referred to as a ‘tick’ and represents financial market data such as, for example, financial quotes or financial news. Each application message (240) may be implemented using a structured document such as, for example, an XML document, a Java object, C++ object, or any other implementation as will occur to those of skill in the art. The message model (244) is metadata that defines the structure and format of the messages (240). The message model (244) may also be implemented using a structured document such as, for example, an XML document, a Java object, C++ object, or any other implementation as will occur to those of skill in the art. The application (238), the message library (248), the messaging middleware (252), the stream administration library (272), and the transport engine (256) illustrated in FIG. 3 are software components, that is computer program instructions, that operate as described above with reference to FIG. 2.

Also stored in RAM (168) is an operating system (154). Operating systems useful in subscribing client devices according to embodiments of the present invention include UNIX™, Linux™, Microsoft NT™, IBM's AIX™, IBM's i5/OS™, and others as will occur to those of skill in the art. The operating system (154), the application (238), the messages (240), the message model (244), the message library (248), the messaging middleware (252), and the transport engine (256) in the example of FIG. 3 are shown in RAM (168), but many components of such software typically are stored in non-volatile memory also, for example, on a disk drive (170).

The exemplary subscribing client device (210) of FIG. 3 includes bus adapter (158), a computer hardware component that contains drive electronics for high speed buses, the front side bus (162), the video bus (164), and the memory bus (166), as well as drive electronics for the slower expansion bus (160). Examples of bus adapters useful in subscribing client devices useful according to embodiments of the present invention include the Intel Northbridge, the Intel Memory Controller Hub, the Intel Southbridge, and the Intel I/O Controller Hub. Examples of expansion buses useful in subscribing client devices useful according to embodiments of the present invention may include Peripheral Component Interconnect (‘PCI’) buses and PCI Express (‘PCIe’) buses. The exemplary subscribing client device (210) of FIG. 3 also includes disk drive adapter (172) coupled through expansion bus (160) and bus adapter (158) to processor (156) and other components of the exemplary subscribing client device (210). Disk drive adapter (172) connects non-volatile data storage to the exemplary subscribing client device (210) in the form of disk drive (170). Disk drive adapters useful in subscribing client devices include Integrated Drive Electronics (‘IDE’) adapters, Small Computer System Interface (‘SCSI’) adapters, and others as will occur to those of skill in the art. In addition, non-volatile computer memory may be implemented for a subscribing client device as an optical disk drive, electrically erasable programmable read-only memory (so-called ‘EEPROM’ or ‘Flash’ memory), RAM drives, and so on, as will occur to those of skill in the art.

The exemplary subscribing client device (210) of FIG. 3 includes one or more input/output (‘I/O’) adapters (178). I/O adapters in subscribing client devices implement user-oriented input/output through, for example, software drivers and computer hardware for controlling output to display devices such as computer display screens, as well as user input from user input devices (181) such as keyboards and mice. The exemplary subscribing client device (210) of FIG. 3 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary subscribing client device (210) of FIG. 3 includes a communications adapter (167) for data communications with other computers (182) and for data communications with a high speed, low latency data communications network (200). Such data communications may be carried out through Ethernet™ connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for terminating an application message subscription according to embodiments of the present invention include modems for wired dial-up communications, IEEE 802.3 Ethernet adapters for wired data communications network communications, and IEEE 802.11b adapters for wireless data communications network communications.

Although FIG. 3 is discussed with reference to exemplary subscribing client devices, readers will note that automated computing machinery used to implement exemplary stream administration servers and exemplary feed adapters useful in terminating an application message subscription according to embodiments of the present invention are similar to the exemplary subscribing client device (210) of FIG. 3. That is, such exemplary stream administration servers and feed adapters include one or more processors, bus adapters, buses, RAM, video adapters, communications adapters, I/O adapters, disk drive adapters, and other components similar to the exemplary subscribing client device (210) of FIG. 3 as will occur to those of skill in the art.

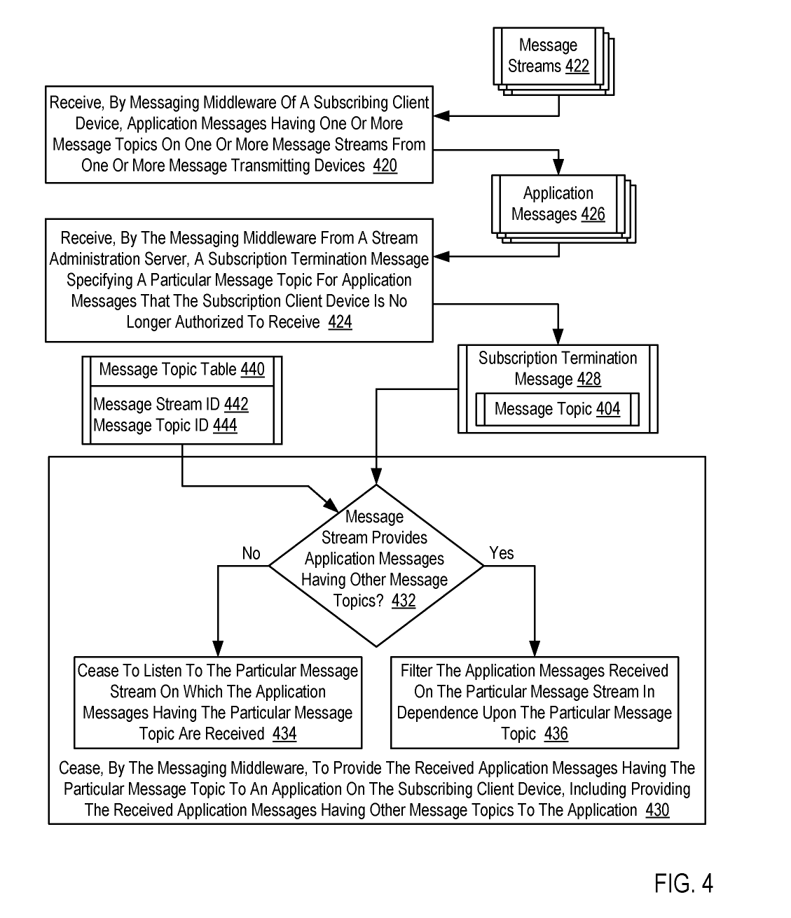

For further explanation, FIG. 4 sets forth a flowchart illustrating an exemplary method of terminating an application message subscription according to embodiments of the present invention. The method of FIG. 4 includes receiving (420), by messaging middleware of a subscribing client device, application messages (426) having one or more message topics on one or more message streams (422) from one or more message transmitting devices. The messaging middleware of the subscribing client device may receive (420) the application messages (426) according to the method of FIG. 4 through the transport engine of the subscribing client device and pass the application messages (426) along to the subscribing client device's application software.

The message streams (422) of FIG. 4 on which the subscribing client device receives (420) the application messages (426) represent data communication channels between a communications endpoint of a subscribing client device and one or more communications endpoints of one or more message transmitting devices. A message stream may be implemented as a multicast data communication channel using the UDP/IP protocols or a unicast data communication channel using TCP/IP protocols as discussed above with reference to FIG. 2.

In the example of FIG. 4, each of the application messages (426) received on the message streams (422) has a message topic. As mentioned above, a message topic identifies a group of application messages having some common characteristics. A message topic is typically used to classify a message based on at least some of contents of the application message. Each application message typically includes a topic data field for storing the message's message topic. Using a message topic, a subscribing client device may specify the group of messages that the subscribing client device (210) requests to receive from the feed adapter (208), or a stream administration server may specify a group of message for which a subscribing client device is no longer authorized to receive. In a financial market data environment, for example, a subscribing client device may use a topic to request to receive ticks from an OPRA feed source that contains quotes of an IBM option traded on the Chicago Board Options Exchange (‘CBOE’) that includes the best bid and best ask for the IBM option on the CBOE.

The method of FIG. 4 includes receiving (424), by the messaging middleware from a stream administration server, a subscription termination message (428) specifying a particular message topic (404) for application messages that the subscription client device is no longer authorized to receive. The subscription termination message (428) of FIG. 4 is an instruction to no longer receive certain application messages from a message transmitting device such as, for example, a feed adapter or a message broker. The subscription termination message (428) of FIG. 4 may be implemented as an XML document, a call to a member method of a RMI object on the subscribing client device, or any other implementation as will occur to those of skill in the art. In the example of FIG. 4, the subscription termination message (428) specifies a particular message topic (404) for application messages that the subscription client device is no longer authorized to receive. The subscribing client device may no longer be authorized to receive such application messages because the subscribing client device may have exceeded a predetermined message quota, reached the end of a time period defined in a contract with a message transmitting device, or any number of other reasons as will occur to those of skill in the art.

As mentioned above, messaging middleware of a subscribing client device may receive the application messages (426) through the transport engine of the subscribing client device. The messaging middleware may then pass the application messages (426) along to the subscribing client device's application software. In response to receiving the subscription termination message (428), the method of FIG. 4 operates for terminating an application message subscription according to embodiments of the present invention by ceasing (430), by the messaging middleware, to provide the received application messages (426) having the particular message topic (404) to an application on the subscribing client device, including providing the received application messages (426) having other message topics to the application for which the application is authorized to receive. That is, the messaging middleware provides the subscribing client device's application with the received application messages (426) having message topics other than the particular message topic (404) specified in the subscription termination message (428).

In the method of FIG. 4, the messaging middleware of the subscribing client device ceases (430) to provide the received application messages (426) having the particular message topic (404) to the subscribing client device's application by determining (432) whether a particular message stream on which the application messages (426) having the particular message topic (404) are received provides application messages (426) having other message topics. The messaging middleware may determine (432) whether a particular message stream on which the application messages (426) having the particular message topic (404) are received provides application messages (426) having other message topics according to the method of FIG. 4 by identifying, from a message topic table (440), the particular message stream providing messages having the message topic (404) and determining whether the identified message stream is associated with any other message topics in the message topic table (440). If the identified message stream is associated with other message topics in the message topic table (440), then the particular message stream on which the application messages (426) having the particular message topic (404) are received provides application messages (426) having other message topics. If the identified message stream is not associated with other message topics in the message topic table (440), then the particular message stream on which the application messages (426) having the particular message topic (404) are received does not provide application messages (426) having other message topics. In the example of FIG. 4, each record of the message topic table (440) represents a message topic currently being subscribed to by the subscribing client device. Each record includes a unique message topic identifier (444) and a message stream identifier (442).

In the method of FIG. 4, the messaging middleware of the subscribing client device ceases (430) to provide the received application messages (426) having the particular message topic (404) to the subscribing client device's application by ceasing (434) to listen to the particular message stream on which the application messages (426) having the particular message topic (404) are received if the particular message stream on which the application messages (426) having the particular message topic (404) are received does not provide application messages (426) having other message topics that the application is subscribed to and authorized to receive. The messaging middleware may cease (434) to listen to the particular message stream according to the method of FIG. 4 by instructing the subscribing client device's transport engine to end the transmission control block associated with the particular message stream on which the application message having the particular topic (404) are received. Ending the transmission control block associated with the particular message stream ensures that the messaging middleware no longer receives any application messages on the particular message stream.

In the method of FIG. 4, the messaging middleware of the subscribing client device also ceases (430) to provide the received application messages (426) having the particular message topic (404) to the subscribing client device's application by filtering (436) the application messages (426) received on the particular message stream in dependence upon the particular message topic (404) if the particular message stream on which the application messages (426) having the particular message topic (404) are received provides application messages (426) having other message topics. The messaging middleware may filter (436) the application messages (426) received on the particular message stream in dependence upon the particular message topic (404) by determining whether the message topic of each application message received on the particular message stream matches the particular message topic (404), discarding the application messages having message topics that match the particular message topic (404), and passing the application messages having message topics that do not match the particular message topic (404) along to the application layer of the subscribing client device.

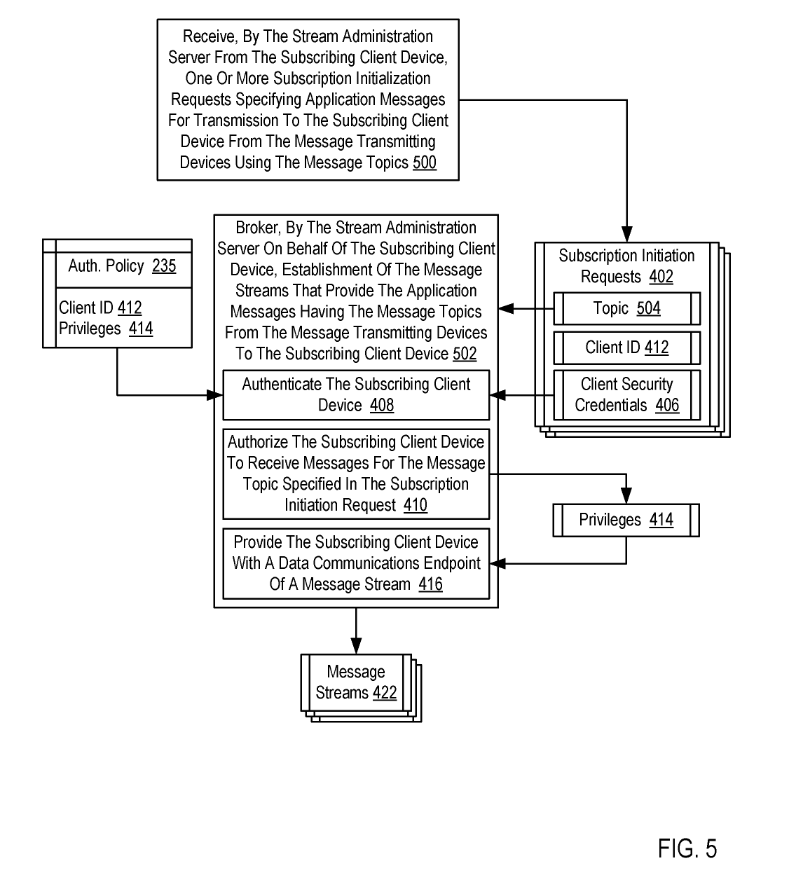

As mentioned above, the subscribing client device receives application messages having one or more message topics on one or more message streams from one or more message transmitting devices. The message streams between the subscribing client device and the message transmitting devices are brokered by a stream administration server. For further explanation, consider FIG. 5 that sets forth a flowchart illustrating a further exemplary method of terminating an application message subscription according to embodiments of the present invention.

In order to terminate an application message subscription, the application message subscription must first be established. The method of FIG. 5 therefore includes receiving (500), by the stream administration server from the subscribing client device, one or more subscription initialization requests (402) specifying application messages for transmission to the subscribing client device from the message transmitting devices using the message topics (504). Each subscription initiation request (402) of FIG. 5 is a request by an application of a subscribing client device to receive data from a message transmitting device. The subscription initiation request (402) of FIG. 4 may be implemented as an XML document, a call to a member method of a RMI object on the subscribing client device, or any other implementation as will occur to those of skill in the art.

Each subscription initiation requests (402) of FIG. 5 specifies a message topic (504), which in turn specifies application messages for transmission to the subscribing client device from a message transmitting device such as, for example, a feed adapter, a message broker, and so on. As mentioned above, a message topic identifies a group of application messages having some common characteristics. A message topic is typically used to classify a message based on at least some of contents of the application message. Each application message typically includes a topic data field for storing the message's message topic. Using a message topic, a subscribing client device may specify the group of messages that the subscribing client device requests to receive from the feed adapter, or a stream administration server may specify a group of message for which a subscribing client device is no longer authorized to receive. In a financial market data environment, for example, a subscribing client device may use a topic to request to receive ticks from an OPRA feed source that contains quotes of an IBM option traded on the Chicago Board Options Exchange (‘CBOE’) that includes the best bid and best ask for the IBM option on the CBOE.

The method of FIG. 5 also includes brokering (502), by the stream administration server on behalf of the subscribing client device, establishment of the message streams (422) that provide the application messages having the message topics (504) from the message transmitting devices to the subscribing client device. The message streams (422) represent data communication channels between a communications endpoint of a subscribing client device and communications endpoints of one or more message transmitting device. A message stream may be implemented as a multicast data communication channel using the UDP/IP protocols or a unicast data communication channel using TCP/IP protocols as discussed above with reference to FIG. 2.

When brokering (400) the establishment of the message streams (422), the stream administration server of the example of FIG. 5 performs several security services to ensure that the subscribing client device only receives messages from the message transmitting device for which the subscribing client device is authorized to receive. In the method of FIG. 5, brokering (502), by the stream administration server on behalf of the subscribing client device, establishment of the message streams (422) is carried out by authenticating (408) the subscribing client device (210). Authenticating (408) the subscribing client device according to the method of FIG. 5 may be carried out by verifying client security credentials (406) provided by the subscribing client device with each subscription initiation request (402). The client security credentials (406) may be implemented as a digital signature in a public key infrastructure, a security token, or any other security data as will occur to those of skill in the art for authenticating the identity of the originator of each subscription initiation request (402). Examples of security tokens may include those security tokens described in the web services specification entitled ‘Web Services Security’ (‘WS-Security’) developed by IBM, Microsoft, and VeriSign or the web services specification entitled ‘Web Services Trust Language’ (‘WS-Trust’) developed by IBM, Microsoft, Veri Sign, OpenNetworks, Layer 7, Computer Associates, BEA, Oblix, Reactivity, RSA Security, Ping Identity, and Actional.

In the method of FIG. 5, brokering (502), by the stream administration server on behalf of the subscribing client device, establishment of the message streams (422) is also carried out by authorizing (410) the subscribing client device to receive application messages for the message topics (504) specified in the subscription initiation requests (402). Authorizing (410) the subscribing client device to receive application messages for the message topics (504) specified in the subscription initiation requests (402) according to the method of FIG. 5 may be carried out by identifying the privileges (414) associated with the authenticated subscribing client device in dependence upon an authorization policy (235). The authorization policy (235) is a set of rules governing the privileges of authenticated subscribing client devices requesting to receive data from a message transmitting device. In the example of FIG. 5, the authorization policy (235) associates privileges (414) with a subscribing client device identifier (412). The subscribing client device identifier (412) represents a subscribing client device authenticated by a stream administration server. The privileges (414) represent the set of application messages permissible for an authenticated subscribing client device identified by the associated authenticated subscribing client device identifier (414) to receive from a message transmitting device. Different authenticated subscribing client devices may have different privileges. Although the authorization policy (235) depicted in FIG. 5 associates individual authenticated users with certain privileges, such a depiction is for explanation and not for limitation. The authorization policy (235) may, in fact, grant privileges on the basis of a subscribing client device's membership in a group or on any other basis as will occur to those of skill in the art.

After performing security services, brokering (502), by the stream administration server on behalf of the subscribing client device, establishment of the message streams (422) according to the method of FIG. 5 is carried out by providing (416) the subscribing client device (210) with a data communications endpoint for each message stream (422) for receiving application messages on that message stream (422). The stream administration server may provide (416) the subscribing client device (210) with a data communications endpoint for each message stream (422) according to the method of FIG. 5 by encapsulating the data communications endpoint information in a message and transmitting the message to the subscribing client device using a Java RMI framework, CORBA framework, web services, or any other manner of data communications as will occur to those of skill in the art. A data communication endpoint may be implemented as a destination address used by the subscribing client device to listen for application messages from the message transmitting device. The destination address may be a multicast address or a unicast address. Using the destination address provided by the stream administration server, the subscribing client device may establish the message stream (280) from the message transmitting device to the subscribing client device.

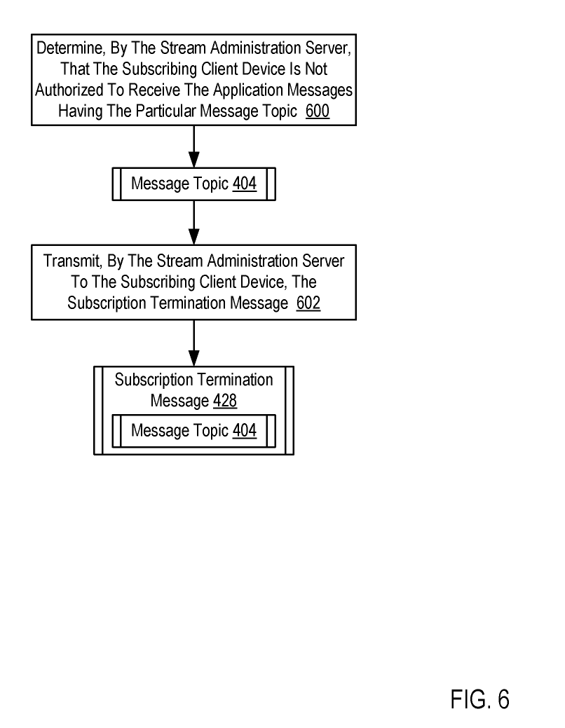

As mentioned above with reference to FIG. 4, the subscribing client device may receive a subscription termination request from a stream administration server. The stream administration server typically transmits a subscription termination message in response to determining that the subscribing client device is no longer authorized to receive application messages having the particular message topic. For further explanation, therefore, consider FIG. 6 that sets forth a flowchart illustrating a further exemplary method of terminating an application message subscription according to embodiments of the present invention.

The method of FIG. 6 includes determining (600), by the stream administration server, that the subscribing client device is not authorized to receive the application messages having the particular message topic (404). The stream administration server may determine (600) that the subscribing client device is not authorized to receive the application messages having the particular message topic (404) according to the method of FIG. 6 by receiving a notification from client account management software that the subscribing client device's account not longer provides access to application messages having the particular message topic (404). The client account management software is a software component that may be installed locally on the stream administration server or some other device that manages accounts for the subscribing client devices. The stream administration server may receive a notification from client account management software that the subscribing client device's account not longer provides access to application messages having the particular message topic (404) because the subscribing client device may have exceeded a predetermined message quota, reached the end of a time period defined in a contract with a message transmitting device, or any number of other reasons as will occur to those of skill in the art.

The method of FIG. 6 also includes transmitting (602), by the stream administration server to the subscribing client device, the subscription termination message (428) in response to determining that the subscribing client device is not authorized to receive the application messages having the particular message topic (404). The stream administration server may transmit (602) the subscription termination message (428) according to the method of FIG. 6 by encapsulating the particular message topic (404) in the subscription termination message (428) and sending the subscription termination message to the subscribing client device using a Java RMI framework, CORBA framework, web services, or any other manner of data communications as will occur to those of skill in the art.

Exemplary embodiments of the present invention are described largely in the context of a fully functional computer system for terminating an application message subscription. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of terminating an application message subscription, the method comprising:
receiving, by messaging middleware of a subscribing client device, application messages having one or more message topics on one or more message streams from one or more message transmitting devices;
receiving, by the messaging middleware from a stream administration server, a subscription termination message specifying a particular message topic for application messages that the subscription client device is no longer authorized to receive; and
ceasing, by the messaging middleware, to provide the received application messages having the particular message topic to an application on the subscribing client device, including providing the received application messages having other message topics to the application.

2. The method of claim 1 wherein ceasing, by the messaging middleware, to provide the received application messages having the particular message topic to an application on the subscribing client device further comprises:
determining whether a particular message stream on which the application messages having the particular message topic are received provides application messages having other message topics; and
ceasing to listen to the particular message stream on which the application messages having the particular message topic are received if the particular message stream on which the application messages having the particular message topic are received does not provide application messages having other message topics.

3. The method of claim 1 wherein ceasing, by the messaging middleware, to provide the received application messages having the particular message topic to an application on the subscribing client device further comprises:
determining whether a particular message stream on which the application messages having the particular message topic are received provides application messages having other message topics; and
filtering the application messages received on the particular message stream in dependence upon the particular message topic if the particular message stream on which the application messages having the particular message topic are received provides application messages having other message topics.

4. The method of claim 1 further comprising:
determining, by the stream administration server, that the subscribing client device is not authorized to receive the application messages having the particular message topic; and
transmitting, by the stream administration server to the subscribing client device, the subscription termination message in response to determining that the subscribing client device is not authorized to receive the application messages having the particular message topic.

5. The method of claim 1 further comprising:
receiving, by the stream administration server from the subscribing client device, one or more subscription initialization requests specifying application messages for transmission to the subscribing client device from the message transmitting devices using the message topics; and
brokering, by the stream administration server on behalf of the subscribing client device, establishment of the message streams that provide the application messages having the message topics from the message transmitting devices to the subscribing client device.

6. The method of claim 1 wherein:
the stream administration server, the subscribing client device, and the message transmitting device are connected for data communications using a high speed, low latency data communications network; and
the message transmitting device is a feed adapter capable of converting application messages received on a feed adapter input stream having a first format to application messages having a second format for transmission on a feed adapter output stream to subscribing client devices.

7. The method of claim 1 wherein the application messages comprises financial market data.

8. A system for terminating an application message subscription, the system comprising one or more computer processors, computer memory operatively coupled to the one or more computer processors, the computer memory having disposed within it computer program instructions capable of:
receiving, by messaging middleware of a subscribing client device, application messages having one or more message topics on one or more message streams from one or more message transmitting devices;
receiving, by the messaging middleware from a stream administration server, a subscription termination message specifying a particular message topic for application messages that the subscription client device is no longer authorized to receive; and
ceasing, by the messaging middleware, to provide the received application messages having the particular message topic to an application on the subscribing client device, including providing the received application messages having other message topics to the application.

9. The system of claim 8 wherein ceasing, by the messaging middleware, to provide the received application messages having the particular message topic to an application on the subscribing client device further comprises:
determining whether a particular message stream on which the application messages having the particular message topic are received provides application messages having other message topics; and
ceasing to listen to the particular message stream on which the application messages having the particular message topic are received if the particular message stream on which the application messages having the particular message topic are received does not provide application messages having other message topics.

10. The system of claim 8 wherein ceasing, by the messaging middleware, to provide the received application messages having the particular message topic to an application on the subscribing client device further comprises:
determining whether a particular message stream on which the application messages having the particular message topic are received provides application messages having other message topics; and
filtering the application messages received on the particular message stream in dependence upon the particular message topic if the particular message stream on which the application messages having the particular message topic are received provides application messages having other message topics.

11. The system of claim 8 wherein the computer memory also has disposed within it computer program instructions capable of:
determining, by the stream administration server, that the subscribing client device is not authorized to receive the application messages having the particular message topic; and
transmitting, by the stream administration server to the subscribing client device, the subscription termination message in response to determining that the subscribing client device is not authorized to receive the application messages having the particular message topic.

12. The system of claim 8 wherein the computer memory also has disposed within it computer program instructions capable of:
receiving, by the stream administration server from the subscribing client device, one or more subscription initialization requests specifying application messages for transmission to the subscribing client device from the message transmitting devices using the message topics; and
brokering, by the stream administration server on behalf of the subscribing client device, establishment of the message streams that provide the application messages having the message topics from the message transmitting devices to the subscribing client device.

13. The system of claim 8 wherein:
the stream administration server, the subscribing client device, and the message transmitting device are connected for data communications using a high speed, low latency data communications network; and
the message transmitting device is a feed adapter capable of converting application messages received on a feed adapter input stream having a first format to application messages having a second format for transmission on a feed adapter output stream to subscribing client devices.

14. A computer program product for terminating an application message subscription, the computer program product disposed upon a computer readable medium, the computer program product comprising computer program instructions capable of:
receiving, by messaging middleware of a subscribing client device, application messages having one or more message topics on one or more message streams from one or more message transmitting devices;
receiving, by the messaging middleware from a stream administration server, a subscription termination message specifying a particular message topic for application messages that the subscription client device is no longer authorized to receive; and
ceasing, by the messaging middleware, to provide the received application messages having the particular message topic to an application on the subscribing client device, including providing the received application messages having other message topics to the application.

15. The computer program product of claim 14 wherein ceasing, by the messaging middleware, to provide the received application messages having the particular message topic to an application on the subscribing client device further comprises:
determining whether a particular message stream on which the application messages having the particular message topic are received provides application messages having other message topics; and
ceasing to listen to the particular message stream on which the application messages having the particular message topic are received if the particular message stream on which the application messages having the particular message topic are received does not provide application messages having other message topics.

16. The computer program product of claim 14 wherein ceasing, by the messaging middleware, to provide the received application messages having the particular message topic to an application on the subscribing client device further comprises:
determining whether a particular message stream on which the application messages having the particular message topic are received provides application messages having other message topics; and
filtering the application messages received on the particular message stream in dependence upon the particular message topic if the particular message stream on which the application messages having the particular message topic are received provides application messages having other message topics.

17. The computer program product of claim 14 further comprising computer program instructions capable of:
determining, by the stream administration server, that the subscribing client device is not authorized to receive the application messages having the particular message topic; and
transmitting, by the stream administration server to the subscribing client device, the subscription termination message in response to determining that the subscribing client device is not authorized to receive the application messages having the particular message topic.

18. The computer program product of claim 14 further comprising computer program instructions capable of:
receiving, by the stream administration server from the subscribing client device, one or more subscription initialization requests specifying application messages for transmission to the subscribing client device from the message transmitting devices using the message topics; and
brokering, by the stream administration server on behalf of the subscribing client device, establishment of the message streams that provide the application messages having the message topics from the message transmitting devices to the subscribing client device.

19. The computer program product of claim 14 wherein:
the stream administration server, the subscribing client device, and the message transmitting device are connected for data communications using a high speed, low latency data communications network; and
the message transmitting device is a feed adapter capable of converting application messages received on a feed adapter input stream having a first format to application messages having a second format for transmission on a feed adapter output stream to subscribing client devices.

20. The computer program product of claim 14 wherein the application messages comprises financial market data.
